(19) United States
(12) Patent Application Publication
(10) Pub. No.: US 2002/0139936 A1
(43) Pub. Date: Oct. 3, 2002

(54) Apparatus for fluorescence detection on arrays

(76) Inventor: David P. Dumas, San Diego, CA (US)

Correspondence Address: CAMPBELL & FLORES LLP, 4370 LA JOLLA VILLAGE DRIVE, 7TH FLOOR, SAN DIEGO, CA, 92122, US

(21) Appl. No.: 10/066,915

(22) Filed: Oct. 25, 2001

Related U.S. Application Data
(60) Provisional application No. 60/244,114, filed on Oct. 27, 2000.

(51) Int. Cl. G01N 21/64

(52) U.S. Cl. 250/458.1

(57) ABSTRACT

The invention provides an apparatus for fluorescence detection, comprising a light source for illuminating a portion of a solid support; a means for splitting light emanating from the light source into two or more split beams of light; a means for polarizing the beams of light; a means for collimating the polarized light; a ¼-wave plate disposed between the collimating means and the solid support for converting the collimated light into polarized light; a means for focusing the polarized light onto the solid support; a means for detecting a fluorescence emission; a means for filtering the fluorescence emission; and a photodetector array.

### FIELD OF THE INVENTION

This application claims the benefit of priority of U.S. Provisional application serial No. 60/244,114, filed Oct. 27, 2000, the entire contents of which is incorporated herein by reference.

The invention relates generally to the field of image detectors and more specifically to methods and an apparatus for detection of a plurality of fluorescent molecules.

### BACKGROUND OF THE INVENTION

The detection of single molecules through fluorescence imaging has become almost routine in many laboratories with the use of commercially available confocal microscopes, epi-fluorescence microscopes, and 2-photon microscopes. The ability to detect single molecules greatly enhances the ability to study biological systems and allows for the analysis of small quantities of fluorescent materials. However, the microscope format does not lend itself to the analysis of large numbers of discrete samples.

A CD-ROM based laser synthesis and detection method has been reported (WO9812559). The reference describes an array disc having a synthesis layer and a second reflective layer located below the synthesis layer. It is apparent from this arrangement that laser light must be directed from the same face as the synthesis layer. A device for light directed synthesis is minimally described in this report as a commercial CD-ROM instrument with only a moderate degree of modification, specifically the exchange of the laser diode with an external laboratory laser light. However, a commercial CD-ROM instrument, without modifications other than the light source, limits the type of chemistry and diversity of reactions as well as the ability to monitor the location and identity of specific compounds on the array disc.

Fluorescence based data storage devices have been described (WO0141131; WO00106501; U.S. Pat. Nos. 4,090,031; 5,278,816; 5,268,862; 6,009,065; and 6,291,132). All of these reports describe multilayer discs with data encoded by laser burning a portion of the fluorescent layer or through the use of photochromic dyes. None of these reports describe the use of specific reflective sectors in conjunction with fluorescent regions. None of these reports describe the measurement of fluorescence intensity for the purposes of quantification of signal and none of these reports describe the use of fluorescence based optical devices for biological assays.

The ability to screen large numbers of discrete samples is the hallmark of high throughput screening and has a role in drug discovery and clinical diagnostics. Among the shortcomings of high throughput screening fluorescence detectors are the low resolution of the sample and the low signal-to-noise ratios.

Thus, there exists a need for efficient methods to detect and resolve a large number of fluorescent signals, for example, in high throughput applications. The present invention satisfies this need and provides related advantages as well.

### SUMMARY OF THE INVENTION

The invention provides an apparatus for fluorescence detection, comprising a light source for illuminating a portion of a solid support; a means for splitting light emanating from the light source into two or more split beams of light, the splitting means disposed between the light source and the solid support; a means for polarizing the beams of light, the polarizing means disposed between the splitting means and the solid support; a means for collimating the polarized light, the collimating means disposed between the polarizing means and the solid support; a ¼-wave plate disposed between the collimating means and the solid support for converting the collimated light into polarized light; a means for focusing the polarized light onto the solid support, the focusing means disposed between the ¼-wave plate and the solid support; a means for detecting a fluorescence emission, the fluorescence detecting means disposed to detect fluorescence emission emanating from the solid support; a means for filtering the fluorescence emission, the filtering means disposed to filter the fluorescence emission onto the fluorescence detecting means; and a photodetector array disposed orthogonal to the polarizing beam splitter for detecting light reflected from the solid support.

### BRIEF DESCRIPTION OF THE DRAWINGS

FIG. 1 shows a perspective view of a scanning confocal fluorimeter.

FIG. 2 shows a schematic diagram of the optical path for a scanning confocal fluorimeter.

FIG. 3 shows a view of electronic control system for a scanning confocal fluorimeter.

FIG. 4 shows a view of a solid support showing the position of sample wells. FIG. 4a shows the assay sector and data and tracking sector of the solid support. FIG. 4b shows a cross section of the solid support, with the dimensions and spacing of assay wells.

FIG. 5 shows an enlarged view of the data/position tracking system. FIG. 5a shows an the data/position tracking system with the central beam on track. FIG. 5b shows the data/tracking system with the central beam off track

FIG. 6 shows an enlarged view of a solid support with data/tracking and fluorescent assay sectors. FIG. 6a shows the reflection of light from a reflective data/tracking pit of the solid support. FIG. 6b shows the fluorescent emission of light from an assay well of the solid support.

FIG. 7 shows a diagram of a method of light tracking using a modification of a DVD-R tracking mechanism.

### DETAILED DESCRIPTION OF THE INVENTION

The present invention provides an apparatus for detecting a plurality fluorescent signals from a solid support. The invention is advantageous in that a large number of fluorescent signals can be resolved and detected in an array-based format. Furthermore, an apparatus of the invention can be used for qualitative analysis of fluorescent signals as well as quantitative analysis of fluorescent signals, including measurement of fluorescence intensity.

An invention apparatus combines the optics of a digital confocal fluorescence microscope with the tracking and scanning features of a laser disc reader. This combination of high resolution, high sensitivity fluorescence scanning with the highly refined optoelectronic engine used for compact discs (CDs) and digital versatile discs (DVDs) provides for a device and methods for interrogating high density fluorescent assays.

High throughput screening is an ideal method for screening a large number of compounds for drug discovery. Fluorescence-based technology is particularly useful as a sensitive system for assay detection (see U.S. Pat. No. 5,876,946, issued Mar. 2, 1999). However, flouorescence-based assays, particularly in a high throughput screening format, are limited by low resolution of the sample and low signal-to-noise ratios. The present invention advantageously combines aspects of a digital confocal fluorescence microscope with the tracking and scanning features of a laser disc reader to provide an apparatus for performing high resolution, high sensitivity fluorescence-based assays that can be applied to numerous samples.

The optics of a confocal microscope are advantageously combined in an invention apparatus to overcome the shortcomings associated with high throughput fluorescent assays by confining illumination and detection to a single point. This is achieved through spatial filters such as pinholes. By focusing a light beam on a single spot, Rayleigh and Raman scattering resulting from impurities in the solvent and optics are minimized and a high signal-to-noise ratio is achieved (Xu and Yeung, Science 275:1106-1109 (1997); Gimzewski and Joachim, Science 283:1683-1688 (1999); Weiss, Science 283:1676-1683 (1999)). These same principles of focusing a light beam on a single spot are used in an invention apparatus to provide a high throughput device capable of resolving fluorescence at the single molecule level. Exemplary optics of a confocal microscope useful in an invention apparatus are described, for example, in U.S. Pat. No. 5,032,720, issued Jul. 16, 1991; U.S. Pat. No. 5,091,652, issued Feb. 25, 1992; U.S. Pat. No. 5,260,578, issued Nov. 9, 1993; U.S. Pat. No. 5,274,240, issued Dec. 28, 1993; U.S. Pat. No. 5,304,810, issued Apr. 19, 1994; U.S. Pat. No. 5,162,941, issued Nov. 10, 1992.

The principles of a laser disc reader commonly used in computer applications do not differ significantly from that of a confocal microscope (Pohlmann, Principles of Digital Audio McGraw-Hill, New York (2000)). A laser disc reader makes use of a photodiode laser to generate a beam of light that passes through a beam splitter and is focused on a discrete target on the surface of the recorded media, the CD disc. Light reflected from specific pits on the surface of the disc is focused through the same optics as the incident light. The reflected light is then reflected by the beam splitter onto a photodetector array. The confocal microscope differs in that, rather than reflected light, emitted light from an excited fluorophore is detected. In addition, the mechanical control of the scanning light with a laser disc reader results from the motion of both the optics and the sample, whereas confocal microscopes generally scan by adjusting the light source.

While an invention apparatus has many similarities in design to a CD-R device, specific and significant modifications that differ from a commercially available CD-R device are made to carry out the fluorescence detection operation of the present invention. The wavelength of light used in the invention apparatus is shorter than that used in CD-R devices. As a result, the diffraction limited range of the collimator lens, diffraction grating for generating the three-beam tracking, the low numerical aperture of the objective lens, and the photodetector array from a CD-R are not compatible with an invention apparatus without modification. Furthermore, the optical components in a CD-R would require repositioning in order to accommodate differences in source divergence from the laser and to allow for focus control of the new laser source, and an invention apparatus has a fluorescence detector.

The present invention provides an apparatus that functions as a scanning confocal fluorimeter. An invention apparatus includes a point light source such as a laser or light focused to a small spot through a spatial filter and imaging optics. The light is directed in a forward path and focused to a small spot on the sample surface. Light emanating from the sample is focused back through the optical path onto a detector. A detector aperture rejects out-of-focus light or light emanating from points bordering the focal spot. The light spot is scanned across the surface of the sample by the combined motion of the sample, which can be in a circular motion, and the optics in a direction orthogonal to the tangent of the sample's movement.

An invention apparatus can also advantageously be used to detect data and tracking information on a solid support. Light emitted from a fluorescent source in a sample well on a solid support is directed to a detector by way of a dichroic beam splitter while reflected light is directed independent of the dichroic beam splitter to a separate detector. As a result of this dual detection system, data can be encoded in specific sectors on the sample support. This data can include, but is not limited to, assay information and light spot tracking information.

Light emitted from a fluorescent source in a sample well on a solid support can optionally be passed through a lens to correct for chromatic aberration in the signal. Fluorescent samples reside in separate assay sectors of the solid support containing sample wells and can reside in discrete wells located along a circular track on the surface of a solid sample support.

The invention provides an apparatus for fluorescence detection comprising a light source, for example, a laser light source, for illuminating an area located on a solid support; a means for collimating light emanating from the light source, the collimating means disposed to allow the light path of the light to pass between the light source and the solid support; a means for focusing the collimated light onto the solid support, the focusing means disposed to allow the light path of the light to pass between the collimating means and the solid support; a means for detecting a fluorescence emission, the fluorescence detecting means disposed to detect fluorescence emission emanating from the solid support; and a means for filtering the fluorescence emission, the filtering means disposed to filter the fluorescence emission onto the fluorescence detecting means.

In an invention apparatus, the light emanating from the light source can be of a wavelength of less than about 8×10⁻⁷ meters. The fluorescence detecting means of an invention apparatus can be selected from the group consisting of a photomultiplier tube, an avalanche detector, and a CCD array.

An invention apparatus can further comprise a means for splitting light emanating from the light source into two or more split beams of light, the splitting means disposed to allow the light path of the light to pass between the light source and the collimating means. An invention apparatus can additionally further comprise a means for polarizing the beams of light, the polarizing means disposed to allow the light path of the light to pass between the splitting means and the collimating means. An invention apparatus can further comprise a means for rotating the plane of polarization of the collimated light, the rotating means disposed to allow the light path of the light to pass between the collimating means and the focusing means. The rotating means can be a polarization deviator such as a ¼-wave plate.

An invention apparatus can also further comprise a means for detecting light reflected from the solid support, the reflected light detecting means disposed to detect light reflected through the focusing means, the polarization deviator, and the collimating means. A reflected light detecting means can be a photodetector array. In one embodiment, the photodetector array is disposed orthogonal to the polarizing means such as a polarizing beam splitter, wherein the polarization deviator is a ¼-wave plate.

An invention apparatus can further comprise a drive mechanism for positioning the light relative to the solid support. Additionally, an invention apparatus can further comprise a computer apparatus for positioning light, which is striking the solid support, relative to the solid support. It is understood that positioning the light source relative to the solid support means that any combination of movement of the light source or any combination of components of the optic block can be moved relative to the solid support so long as the location of light striking the solid support is positioned at a particular location on the solid support.

The invention additionally provides an apparatus for fluorescence detection comprising a light source, for example, a laser light source, for illuminating an area located on a solid support; a collimator lens disposed to allow the light path of the light to pass between the light source and the solid support for collimating the light emanating from the light source; an focusing lens disposed to allow the light path of the light to pass between the collimator lens and the solid support for focusing the light onto the solid support; a fluorescence detector disposed to detect fluorescence emission emanating from the solid support; a means for filtering the fluorescence emission, the filtering means disposed to filter the fluorescence emission onto the fluorescence detecting means. The light emanating from the light source of such an invention apparatus can be of a wavelength of less than about 8×10⁻⁷ meters. A fluorescence detector of such an invention apparatus can be selected from the group consisting of a photomultiplier tube, an avalanche detector, and a CCD array.

An invention apparatus can further comprise a diffraction grating disposed to allow the light path of the light to pass between the light source and the collimator lens, the diffraction grating including a grating for splitting light emanating from the light source into two or more split beams of light. An invention apparatus can also further comprise a polarizing beam splitter disposed to allow the light path of the light to pass between the diffraction gating and the collimator lens for polarizing the beams of light.

An invention apparatus can additionally further comprise a polarization deviator disposed to allow the light path of the light to pass between the collimator lens and the focusing lens for rotating the plane of polarization of the collimated light. The polarization deviator can be, for example, a ¼-wave plate. An invention apparatus can further comprise a photodetector array disposed to detect light reflected from the solid support through the focusing lens, the polarization deviator, and the collimator lens. The photodetector array can be disposed orthogonal to the polarizing beam splitter, wherein the polarization deviator is a ¼-wave plate.

An invention apparatus can further comprise a drive mechanism for positioning the light relative to the solid support. The apparatus can additionally further comprise a computer apparatus for positioning the light relative to the solid support

The invention additionally provides an apparatus for fluorescence detection comprising a light source for illuminating a portion of a solid support; a means for splitting light emanating from the light source into two or more split beams of light, the splitting means disposed to allow the light path of the light to pass between the light source and the solid support; a means for polarizing the beams of light, the polarizing means disposed to allow the light path of the light to pass between the splitting means and the solid support; a means for collimating the polarized light, the collimating means disposed to allow the light path of the light to pass between the polarizing means and the solid support; a ¼-wave plate disposed to allow the light path of the light to pass between the collimating means and the solid support for converting the collimated light into polarized light; a means for focusing the polarized light onto the solid support, the focusing means disposed to allow the light path of the light to pass between the ¼-wave plate and the solid support; a means for detecting a fluorescence emission, the fluorescence detecting means disposed to detect fluorescence emission emanating from said solid support; a photodetector array disposed orthogonal to the polarizing beam splitter for detecting light reflected from the solid support; and a means for filtering the fluorescence emission, the filtering means disposed to filter the fluorescence emission onto the fluorescence detecting means.

As used herein, a “solid support” refers to any solid medium suitable for attaching a chemical moiety and for tracking and storing information on the location and composition of attached chemical compounds. The solid support can be transparent to light, allowing excitation of fluorescent molecules on the side of the solid support opposite of the light source and other optics of an invention apparatus. If desired, the solid support can have portions that are transparent, rather than the entire solid support being transparent. For example, the solid support can be transparent to light at discrete locations such as the assay wells. The solid support comprises at least two types of sectors, a data and tracking sector and an assay sector. The solid support generally contains several data and tracking sectors interspersed between assay sectors, allowing more accurate positioning of the light source at discrete locations on the solid support. The nature of the data and tracking sector and the assay sector are described in more detail below. An apparatus of the invention can be used such that the data tracking and assay sector are a single layer, that is, essentially in the same plane on the solid support.

In one embodiment of the invention, the solid support is in the form of a compact disc (CD) rotatable or recordable media composed of transparent plastic, silicon or glass. The grooves on a standard audio CD are 0.5 microns (0.5 μm) wide, and the expanding spiral of pits in this groove is separated by 1.6 microns. This gives rise to a data track that would be 4 miles long if stretched out. Thus, an invention solid support used in an invention apparatus can encode data, instructions and protocols using standard CD formatting as well as sample wells in discrete locations on the assay sector of the solid support. The data is encoded as opticoelectric data, that is, data that can be read by an optical and/or electrical device. The sample wells are distributed along the 0.5 micron wide groove in discrete 1 micron pits. A solid support in the form of a standard sized CD contains sufficient space to contain at least 310×10⁶ sample wells in 1×0.5 micron pits. It is understood that, while the above-described solid support is in the format of a traditional CD with a spiral groove of pits, any format suitable for an invention apparatus disclosed herein can be used so long as the format has one or more data and tracking sectors and one or more assay sectors.

When using a CD format, error correction mechanisms can be used to compensate for the speed of rotation of the solid support or a difference in rotation speed between the central regions and outer regions of the solid support. For example, redundant wells containing replicates of the same sample in replicate sample wells can be used. Error correction can be performed using well known algorithms such as those used in a CD player.

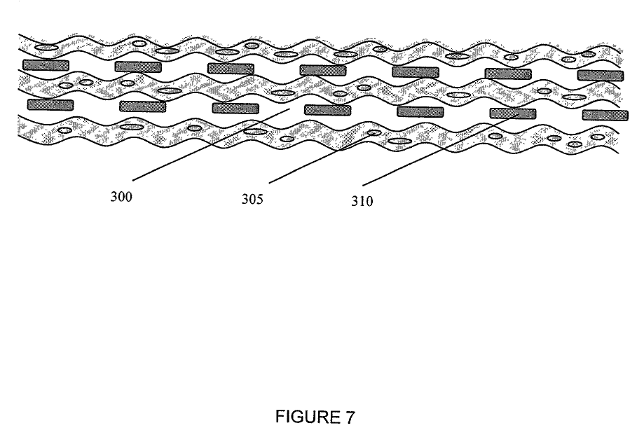

In another embodiment, the solid support is molded or etched in a manner analogous to a DVD-R device (Pohlmann, Principles of Digital Audio, pp. 363-438 McGraw-Hill, New York (2000)). The assay sector is contained within a spiral pregroove molded or etched into the surface of the solid support while the tracking sector is correlated to the land between the pregrooves (FIG. 7). Discrete assay wells are molded into the bottom of the pregroove. The pregroove is slightly wobbled side to side at a fixed frequency to generate a critical carrier signal for motor control, tracking, and focus when illuminated by the laser. Specific tracking information can be further encoded in the form of pits (land pre-pits) molded or etched on the land areas between the coils of the pregroove. As the laser beam follows the pregroove, the land pre-pits are contacted peripherally and create a pattern of light reflected back to the photodetector. Since the land pre-pits generate a different signal frequency than the pregroove wobble, the encoded information can be extracted and used. For example, the encoded information can be used to locate and identify the positions of samples distributed on assay wells of a solid support.

A modification of a DVD-R tracking mechanism useful in an apparatus invention is illustrated in more detail in FIG. 7. A pregroove 300, which can be in the form of a spiral on the solid support, is molded into the surface of the solid support with a side-to-side wobble of a certain frequency. Land pre-pits 305 are molded into the area between the pregrooves. Assay wells, 310, are molded into pregrooves. Such an arrangement is useful for providing tracking information on the location and identity of assay wells distributed on the solid support, for example, information on the distribution of particular samples at specific positions on the solid support. Thus, a tracking sector can be formatted in a method analogous to a DVD-R device, where an undulating wobble signal is molded into a groove for synchronizing a drive spindle motor using a frequency modulation (FM) encoding scheme. Due to the proximity of the tracking sites and the assay wells, such an arrangement can provide more accurate tracking information.

As used herein, a “light source” refers to a device that produces electromagnetic radiation of the appropriate wavelength for an invention apparatus. The light source can be, for example, a laser that emits light at a distinct wavelength. A light source can also emit a range of wavelengths, which can optionally be filtered to obtain a particular wavelength or range of wavelengths. Such a light source can be, for example, a hydrogen or deuterium lamp, a tungsten lamp, or a light emitting diode (LED). When using a light source emitting at multiple wavelengths, a filter can optionally be used to produce light of a particular wavelength or range of wavelengths. As used herein, the phrase “light emanating from a light source” refers to the light as directly emitted by the light source or to the light after passing through a filter for selecting a particular wavelength or range of wavelengths.

As used herein, a “laser light source” refers to a device capable of converting electromagnetic radiation of mixed frequencies to one or more discrete frequencies of highly amplified and coherent radiation and emitting the radiation in the form of light at a predetermined wavelength. The laser light source can be designed to emit light at a single frequency, at variable frequencies or at multiple frequencies.

A light source, for example, a laser light source, useful in an invention apparatus generally will emit light of a wavelength of less than about 8×10⁻⁷ meters. However, it is understood that the light source useful in an invention apparatus can emit light at any wavelength of electromagnetic radiation suitable to excite a fluorescent molecule attached or bound to a solid support. For example, the light source can emit light of about 8×10⁻⁷ meters, about 7×10⁻⁷ meters, about 6×10⁻⁷ meters, about 5×10⁻⁷ meters, about 4×10⁻⁷ meters, about 3.5×10⁻⁷ meters, about 3.4×10⁻⁷ meters, about 3.3×10⁻⁷ meters, about 3.2×10⁻⁷ meters, about 3.1×10⁻⁷ meters, about 3×10⁻⁷ meters, about 2.9×10⁻⁷ meters, about 2.8×10⁻⁷ meters, about 2.7×10⁻⁷ meters, about 2.6×10⁻⁷ meters, about 2.5×10⁻⁷ meters, about 2.4×10⁻⁷ meters, about 2.3×10⁻⁷ meters, about 2.2×10⁻⁷ meters, about 2.1×10⁻⁷ meters, about 2×10⁻⁷ meters, or any wavelength useful for cleaving a given photocleavable reagent. One skilled in the art can readily determine an appropriate light source for sufficient excitation of a fluorescent molecule. The light source is sufficient for exciting a fluorescent molecule, and is generally optimal for exciting a fluorescent molecule.

The light source can be positioned on the side of the solid support opposite of where the fluorescent molecules are located or on the same side as the fluorescent molecules. When the fluorescent molecules are on the opposite side of a transparent solid support such that light passes through the solid support before illuminating a fluorescent molecule, the light source is chosen to emit light at a wavelength or range of wavelengths so that the wavelength of light that strikes the fluorescent molecule is sufficient to excite the molecule for fluorescence emission. Thus, the light source can be chosen such that, upon passage through the solid support, light strikes the fluorescent molecules at about 5×10⁻⁷ meters, about 4×10⁻⁷ meters, about 3.5×10⁻⁷ meters, about 3.4×10⁻⁷ meters, about 3.3×10⁻⁷ meters, about 3.2×10⁻⁷ meters, about 3.1×10⁻⁷ meters, about 3×10⁻⁷ meters, about 2.9×10⁻⁷ meters, about 2.8×10⁻⁷ meters, about 2.7×10⁻⁷ meters, about 2.6×10⁻⁷ meters, about 2.5×10⁻⁷ meters, about 2.4×10⁻⁷ meters, about 2.3×10⁻⁷ meters, about 2.2×10⁻⁷ meters, about 2.1×10⁻⁷ meters, about 2×10⁻⁷ meters, or any wavelength useful for exciting a fluorescent molecule. One skilled in the art can readily determine an appropriate light source sufficient for excitation of a fluorescent molecule and stimulation of a fluorescent emission. The light source is sufficient for exciting a fluorescent molecule, and is generally optimal for exciting a fluorescent molecule. Furthermore, one skilled in the art can readily determine an appropriate light source for sufficient excitation of a fluorescent molecule by measuring fluorescence for a particular fluorescent molecule by varying the wavelength or range of wavelengths emanating from the light source.

As used herein, “means for collimating” or “collimating means” refers to a device for collimating light emanating from the light source. Collimated light emanating from a collimating means is lined up or parallel. A collimating means can also include fiber optic cables or parabolic mirrors, or any means to produce a parallel light source. An exemplary collimating means is a collimator lens. The collimating means is generally disposed to allow the light path of the light to pass between the light source and the solid support, and can be disposed to allow the light path of the light to pass between a polarizing means and a polarizing means such as a polarizing means such as a polarization deviator.

As used herein, “means for focusing” or “focusing means” refers to a device for focusing collimated light onto a solid support. An exemplary focusing means is a focusing lens, such as an objective lens, or a fiber optic cable. The focusing means is generally disposed to allow the light path of the light to pass between the collimating means and the solid support and can be disposed to allow the light path of the light to pass between the polarization deviator and the solid support. The focusing means is generally designed to focus light on a predefined area of the solid support. As used herein, the term “area,” when used in reference to a solid support, refers to the measure of a planar region of the solid support, that is, the geometric dimensions. In particular, the focusing means focuses light on the solid support of a predefined area. For example, the lens can be used to focus light on an area of about 1 μm². Generally, the area of focus is designed such that the area of focused light strikes a limited number of sites, for example, a limited number of sample well pits, and preferably focuses on a single pit. Similarly, the focused light preferably focuses on a single tracking and data site.

If desired, the area of focus can be varied for particular applications, for example, by varying the distance between the focusing means and the solid support. The focusing means can be varied to focus light on an area of about 0.1 μm² to an area about the size of the solid support. When focused to an area of about 1 μm², a typically sized solid support of a standard size CD allows, excluding data and tracking sectors, at least about 3×10⁸ sample wells.

The collimating means and focusing means can be separate means such as a separate collimator lens and focusing lens. Optionally, the collimating means and focusing means can be a single means such as a fused collimator lens and focusing lens.

As used herein, “means for detecting a fluorescence emission” or “fluorescence detecting means” refers to a device for detecting fluorescence emission emanating from a solid support. Exemplary fluorescence detecting means include a photomultiplier tube, an avalanche detector, and a charge coupled device (CCD) array. A fluorescence detecting means is generally disposed to detect fluorescence emission emanating from the solid support, preferably disposed in a position to optimally detect fluorescence emission from the solid support.

The fluorescence detecting means can be positioned to detect fluorescence emissions from a solid support after filtering the fluorescence emission, where filtering means disposed to filter the fluorescence emission onto the fluorescence detecting means. A filtering means is useful for rejecting out-of-focus components of the fluorescence emission, for example, to more precisely measure emission from a sample well, as disclosed herein. Exemplary filtering means include any device that can filter the fluorescence emission to detect preferred emissions, for example, a device with a pinhole or appropriate sized aperture such as a confocal aperture.

As used herein, “means for splitting” or “splitting means” refers to a device for splitting light emanating from the light source into two or more split beams of light. An exemplary splitting means is a diffraction gradient or diffraction grating as well as appropriately positioned fiber optic cables. A diffraction grating consists of a screen with slits spaced a few wavelengths apart. The light can be of a predetermined wavelength and intensity. As the beam passes through the grating, it diffracts at different angles. A splitting means is generally disposed to allow the light path of the light to pass between the light source and the collimating means.

As used herein, “means for polarizing” or “ipolarizing means” is a device for polarizing the beams of light split by a splitting means. An exemplary polarizing means is a polarizing beam splitter. The polarizing means is used to polarize light to be directed to the solid support. The polarizing means is generally disposed to allow the light path of the light to pass between the splitting means and the collimating means.

As used herein, “means for rotating” or “rotating means” refers to a device that changes the plane of polarization of polarized light. One such device that rotates the plane of polarization is a “polarization deviator.” An exemplary polarization deviator is a ¼-wave plate, which rotates the plane of polarization by 45°. It is understood that any device that rotates the plane of polarization to desired angle can be used as a rotating means such as a polarization deviator, so long as the polarization deviator does not rotate the plane of polarization by 90°, which would result, after passing through the polarization deviator two times, in reflected light passing through the polarizing beam splitter. A rotating means is generally disposed to allow the light path of the light to pass between the collimating means and the focusing means.

As used herein, “means for detecting reflected light” or “reflected light detecting means” refers to a device capable of detecting light reflected from the solid support. An exemplary detecting means is a photodetector array. The detecting means is positioned so that light reflected from the solid support can be detected. When light is passed through a polarizing means, the detecting means is positioned such that light rotated by the polarizing means can be detected. When the polarizing means is a ¼-wave plate, the detecting means is generally positioned orthogonal to the polarizing beam splitter for optimal detection of the reflected light. It is understood that the detecting means can be positioned at any location so long as a sufficient amount of reflected light can be detected for use in an apparatus of the invention, and is preferably positioned for optimal detection of light reflected from the solid support.

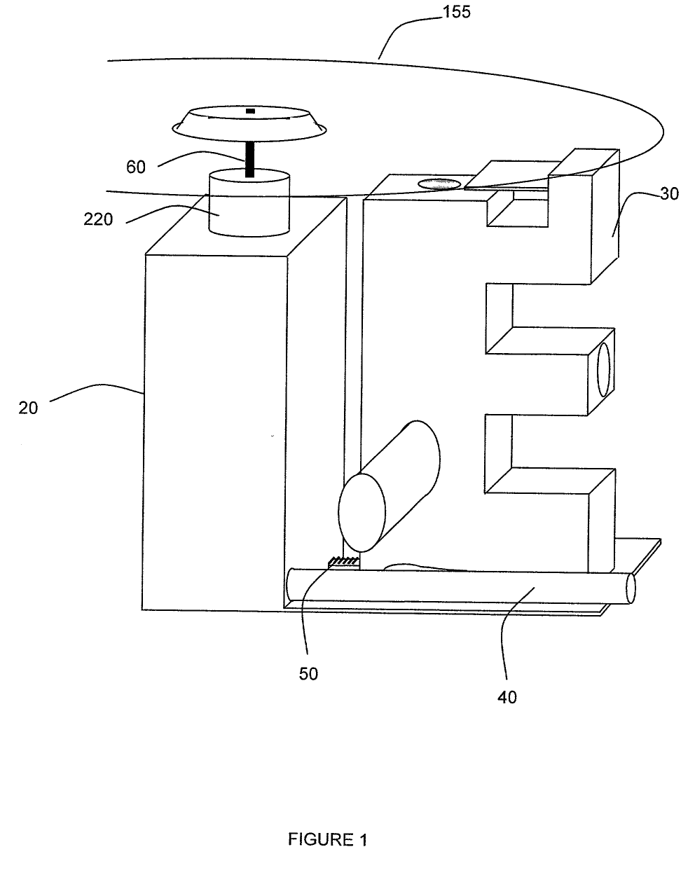

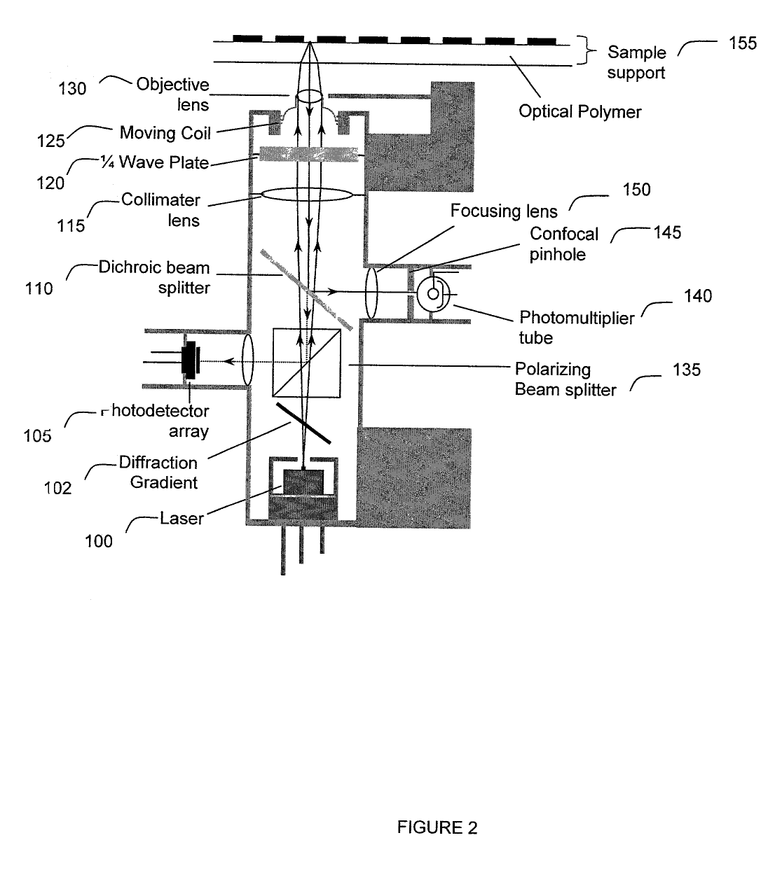

FIG. 1 shows a perspective view of an exemplary apparatus of the invention. Referring to FIG. 1, a solid support is depicted as disc 155. The housing for a drive motor for rotating solid support 155 is depicted as drive housing 20. The housing for a light source and optics for directing light to solid support 155 and detecting flourescent signals therefrom is depicted as optics housing 30. Positioning bar 40 is used to move the optics housing along track 50 so that the light can be directed at various distances from spindle 60, which can be rotated by variable speed drive 220. FIG. 2 shows a pictorial view of the optical path for a scanning confocal fluorimeter of an invention apparatus. The basic operation of the scanning confocal fluorimeter involves the generation of a small beam of light by way of a photodiode laser and directing this light as a small spot onto the surface of a solid support containing multiple samples. The light is then scanned across the support by the combined rotation of the support and the transverse movement of the optics. This combined motion causes the light beam to trace a spiral pattern from the center of the support to the outer edge of the support. Typically, the light of interest is either emitted fluorescent light or light reflected from the support, which can be used for tracking the location on the solid support.

In one embodiment, the scanning confocal fluorimeter tracks two types of sectors on the solid support. One sector is composed of reflective elements that encode tracking information by binary code. This data is used as a marker for laser light alignment and positional calibration. The second type of sector contains sample wells, which can be contacted with fluorescent molecules and detected using an invention apparatus. One example of a sample would be a peptide to which a fluorescently labeled antibody was bound. The excitation light from the photodiode laser is split into three beams by a diffraction grating, creating a central peak plus two side peaks. The two side peaks are important in the tracking mechanism.

The three beams of light pass through a polarization beam splitter. The emerging light is then collimated by means of a lens. The collimated light goes through a ¼-wave plate that rotates the plane of polarization 45°. This light is then focused onto the solid support by means of focusing lens such as an objective lens that is optionally attached to a two-axis actuator and servo system for an up/down focusing and lateral tracking motion via a moving coil. The moving coil consists of a servo system that moves the focusing lens up and down to maintain a depth of focus within tolerance. A feedback circuit from the photodetector to the computer apparatus can decipher a focus correction signal and generate a servo control voltage, which in turn controls the actuator to move the focusing lens. The focusing lens such as an objective lens is displaced in the direction of its optical axis by a coil and permanent magnet. The central light beam is focused to a desirable area suitable for tracking and fluorescence detection purposes, for example, an approximately 1.0 μm² area, at the surface of the solid support.

The solid support comprises two sectors, a data and tracking sector and an assay sector. The assay sector contains a plurality of discrete sample wells, generally indentations or pits, into which assay samples are distributed. The data and tracking sector is used to store information on the location of sample wells and to guide or track the light source to discrete areas of the solid support. The solid support can be composed of glass, silicon, plastic, and the like, or any solid medium of appropriate composition. If desired, the solid support can be composed of a transparent medium through which light can pass if fluorescent molecules reside on the opposite side of the solid support from the light source.

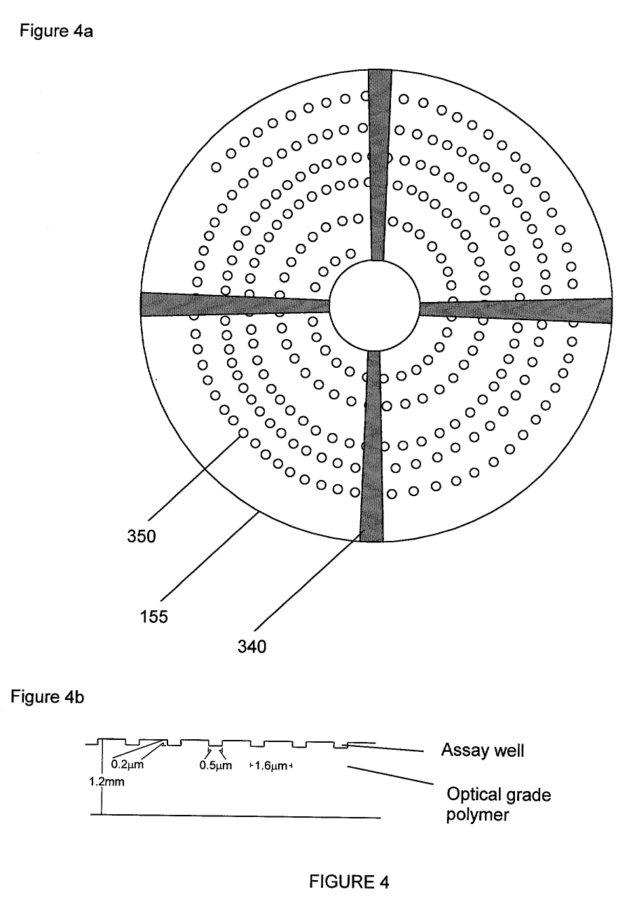

In the data and tracking sector, the central light beam is focused to a predetermined area and a discrete location at the surface of the solid support. The light then strikes the solid support, passing through the solid support if transparent, on a reflective region distinguished by a series of indentations or pits. If the light source is on the opposite side of the solid support as the assay wells, these pits appear as elevated regions ¼ wavelength high from the direction of the light beam (see FIG. 4a). Reflected light from these pits is 90° out of phase from the incident light and thus causes destructive interference. Thus, if the light strikes the pit, it is not reflected. Light reflected from the region outside of the pit is not diminished in intensity as a result of destructive interference and thus passes back into the focusing lens. The reflected light then passes through the ¼ wave plate again, where it is now polarized orthogonal to the incident light. As a result, it is reflected by the beam splitter and focused onto a photodetector array (see FIG. 2). Optionally, a filter can be disposed to allow the light path of the light to pass between the beam splitter and the photodetector array to filter the reflected light onto a photodiode of the photodetector array.

In addition to striking a data and tracking sector, as described above, the polarized light can also strike a sector of the solid support used for assay analysis. In this case, fluorescent light is emitted from the fluorophore, and this light is directed through the instrument optics to a dichroic beam splitter. The longer wavelength of the fluoresced light is reflected from the dichroic beam splitter through a confocal aperture that assures only light from the target sample is detected. That light which passes through the aperture is captured by a photodetector. The photodetector can be, for example, a photomultiplier tube, an avalanche photodetector, or a CCD array.

An exemplary invention apparatus is depicted in FIG. 2. Referring to FIG. 2, a laser light source is depicted as laser 100. Light is emitted from the laser through diffraction gradient or diffraction grating 102, where light is split into multiple beams. The split beams are polarized by polarizing beam splitter 135. The polarized light is collimated by collimator lens 115. The collimated light passes through ¼-wave plate 120, resulting in rotation of the polarized light. The rotated polarized light passes through objective lens 130 so that the light is focused on solid support 155. The solid support can be, for example, an optical polymer through which light can pass. The objective lens can optionally be positioned relative to the solid support with a moving coil 125. Light is reflected from solid support 155, back through objective lens 130, ¼-wave plate 120, collimator lens 115, and polarizing beam splitter 135, where the reflected light is deflected to photodetector array 105. When light strikes an assay well of solid support 155 containing a fluorescent molecule, fluorescent light is emitted back through objective lens 130, ¼-wave plate 120, and collimator lens 115, and is deflected by dichroic beam splitter 110. The emitted fluorescent light is reflected from dichroic beam splitter 110 through focusing lens 150 and confocal pinhole 145. Light passing through confocal pinhole 145 is captured by photomultiplier tube 140.

Although the above embodiment is described using an optical device containing lenses and is positioned as an optical unit relative to the solid support, it is understood that any combination of lenses, mirrors, and/or fiber optic cables can be used in an invention apparatus in any appropriate order so long as light can be directed to particular locations on the solid support sufficient for fluorescent assay detection and/or data tracking. Furthermore, it is understood that any of the collimating means, focusing means, splitting means, polarizing means, rotating means, and/or detecting means can be positioned relative to other means so long as the path of light passes through the means in a manner sufficient to illuminate a solid support for fluorescent assay detection and/or data tracking.

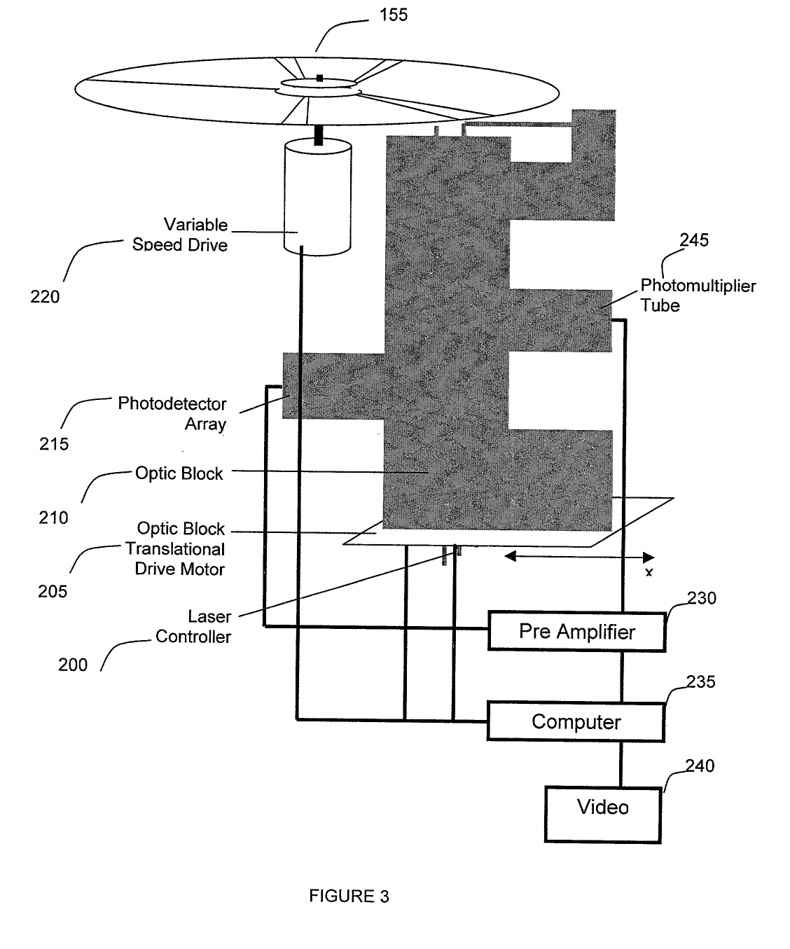

A more detailed view of the electrical design of an embodiment of an invention appratus is shown in FIG. 3. The photodetector array is used to convert the light signal into a radio frequency (Rf) signal. The Rf signal from the photodiode is amplified (via a pre amplifier) and decoded prior to processing by computer apparatus such as a micro computer. The computer apparatus can be interfaced with an output device, such as the video output device depicted in FIG. 3, or can optionally be interfaced with other output devices suitable for recording data, if desired, including recordable media such as a floppy disc, zip disc, writable CD, and the like. The computer apparatus can be used to control, via a software application, the movement of the optic block, drive motor, focusing lens, tracking, and/or light source such as laser power. For example, as depicted in FIG. 3, the computer apparatus can be interfaced with a light controller such as a laser controller to regulate the intensity and/or wavelength of the light. The computer apparatus can also be interfaced with an optic block translational drive motor, which can be used to position the optics such that light is focused at a discrete location on the solid support. The computer apparatus can additionally be interfaced with a variable speed drive motor such as that depicted in FIG. 3 to regulate the speed of rotation and positioning of the solid support relative to the optic block.

Referring to FIG. 3, photodetector array 215 detects light reflected from solid support 155, where the signal is converted to a radiofrequency signal and amplified through pre amplifier 230 and decoded prior to processing by computer apparatus 235. Computer apparatus 235 is interfaced with an output device such as video monitor 240. Computer apparatus 235 is also interfaced with laser controller 200. Laser controller 200 is connected to optic block translational drive motor 205, which is connected to optic block 210. Computer apparatus 235 is also interfaced with optic block translational drive motor 205, allowing positioning of the optic block relative to the solid support. Computer apparatus 235 is also interfaced with variable speed drive motor 220, allowing control of the speed of rotation and positioning of specific locations on the solid support relative to optic block 210. Computer apparatus 235 is additionally interfaced with photomultiplier tube 245 for detection of fluorescent emissions from solid support 155. The computer control allows for variable speed control of the sample support drive motor, transverse movement of the optic block, control of the laser power and pulsing, alignment of the optical path, and capture of data from the detectors.

In addition to controlling the relative position of the optics and the solid support, the computer apparatus can also be used to regulate the light source. As described above, the intensity and wavelength of the light can be regulated. Furthermore, whether the light is striking the surface of the solid support can also be regulated. Control of the spatial coordinates of the light beam at a discrete location of the solid support for excitation of fluorescent molecules in the assay sector can be achieved by employing a shutter to block the light beam from striking the surface of the solid support or by causing a pulse of light through electronic control. Any means for pulsating the light beam can be used in an invention apparatus. Control of pulsation of the light can be conveniently regulated by a computer apparatus interfaced with a light source including, for example, a laser controller (see FIG. 3).

Although the above described invention apparatuses are preferably interfaced with a computer apparatus for controlling the relative position of the solid support and the optics of the apparatus, it is understood that an invention apparatus for fluorescence detection can be operated manually, if desired.

A simplified depiction of the surface of the sample support is shown in FIG. 4a. Reflective sectors (340) on the solid support are interspersed between assay sectors in which assay wells (350) are arranged in a long single spiral track. This track can have any dimensions suitable for detection in an invention apparatus. Exemplary dimensions of an assay track are shown in FIG. 4b, where the assay wells are depicted as 2 μm×0.5 μm×0.11 μm pits along groves separated 1.6 μm. The solid support can be composed of any appropriately transparent medium, including glass or a plastic.

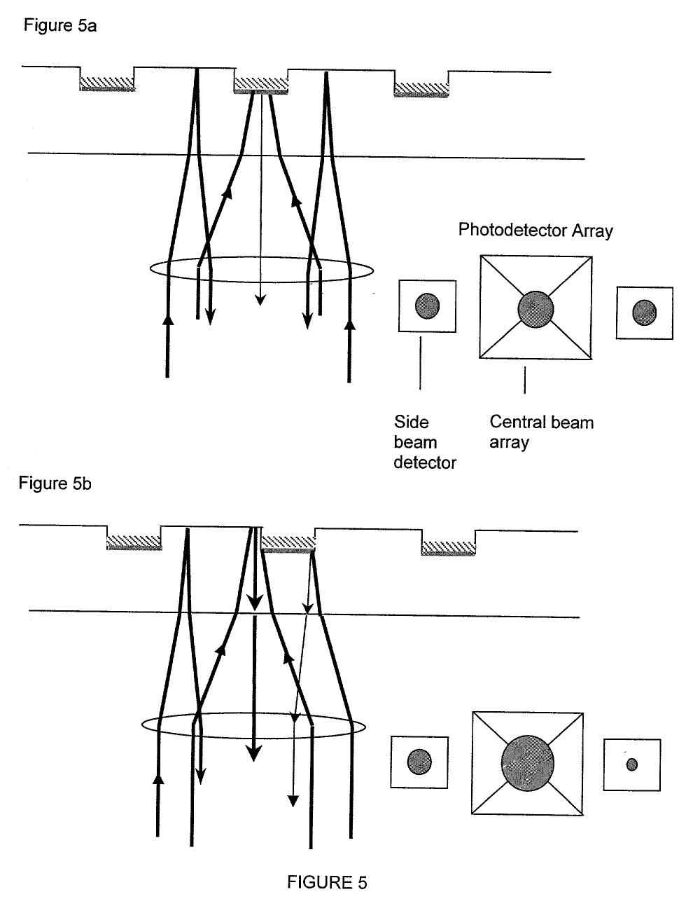

The method by which the tracking system is used to focus light on a particular sector of the solid support is shown in FIG. 5. The three beams are conveyed to the support surface through a focusing lens such as an objective lens. The central beam strikes the pit track, while the two tracking beams are aligned offset to either side of the central beam. During proper tracking, as shown in FIG. 5a, the tracking beams strike the area of the support between the pit tracks and is reflected through the focusing objective lens, ¼ wave plate, and polarizing beam splitter onto the photodetector array. The tracking beams strike two separate photodiodes mounted to either side of the main four-quadrant photodiode. If tracking is precisely aligned, the difference between the tracking signals is zero. If the three light beams drift to either side of the pit track (FIG. 5b), the amount of light reflected from the tracking beams varies as one of the beams encounters more pit area creating a difference signal in the photodiodes. To correct for tracking errors, a correction voltage is applied to an actuator on the focusing lens, for example, an objective lens, so that the main light spot is again centered as in FIG. 5a. Although the above described tracking system uses three beams of light, it is understood that since a splitting means is optional in an invention apparatus, that a single beam, or any number of desirable beams, can also be used for tracking purposes in an invention apparatus.

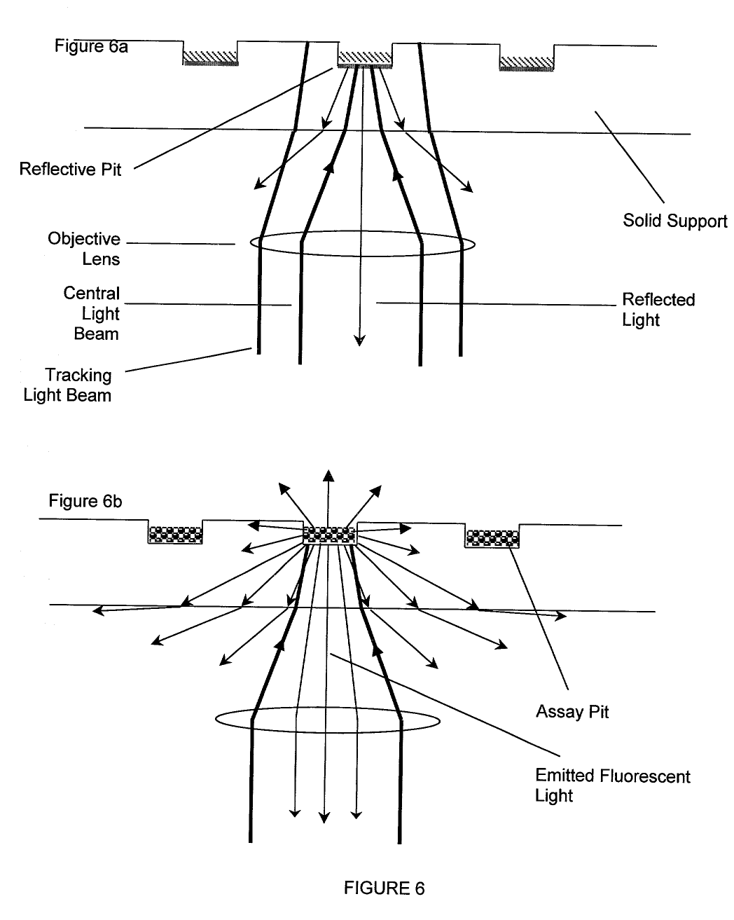

A detailed view of the optical path at the surface of the support is shown in FIG. 6. As exemplified in FIG. 6, the light beam is focused on the pit of a tracking sector (FIG. 6a) or an assay sector (FIG. 6b). As depicted in FIG. 6, the increased refractive index of the solid support plays a role in the focusing of the light beam. The reflected light exits the solid support, where out-of-focus beams are refracted from the optics as a result of decreased refractive index of air.

An assay sector showing emitted fluorescent signal from a fluorescent sample is depicted in FIG. 6b. The sample sector contains fluorescent molecules. Any of a variety of fluorescent moieties can be used for a flourescent assay. A particularly useful fluorophore is atto-tag CBQCA from Molecule Probes (Eugene Oreg.). For this fluorophore, a 450 nm photodiode laser is used to generate the exciting light beam. This light excites the fluorophore, which emits light at about 550 nm. This longer wavelength light is reflected by the dichroic beam splitter through a pinhole aperture. This pinhole ensures that stray light from adjacent sectors is not detected.

Other exemplary fluorescent tags suitable in methods of the invention include green fluorescent protein, BODIPY (4,4-difluoro-4-bora-3a,4a-diaza-5-indacene), cascade blue, fluoroscein isothiocyanate (FITC), Cy3, rhodamine, Texas Red, quantum dots, europium complexes, and the like.

An invention apparatus can conveniently be used to assay a plurality of samples on a solid support that can be detected by flourescence and is particularly useful for detecting fluorescence of a large number of samples, for example, on an array. The invention provides a method of detecting fluorescence on a solid support. The method includes the steps of (a) focusing light onto a solid support, the solid support comprising a plurality of sample wells, wherein the sample wells were contacted with one or more fluorescent molecules; (b) measuring fluorescence emission from a sample well; and (c) repeating step (b) one or more times, wherein the repeated steps are performed at the same or a different position on the solid support relative to the previous measurement. If desired, any number of replicate wells containing the same sample can be used for validating and quantitating the assay. The methods can be performed using any apparatus of the invention, as disclosed herein.

The invention also provides an apparatus for fluorescence detection comprising a solid support comprising an assay sector, the assay sector comprising a plurality of sample wells at discrete locations on the solid support, and a data tracking sector, wherein the data tracking sector indicates the position of the multiple discrete locations of the sample wells; and a light source positioned for illuminating an area located on the solid support.

The invention further provides an apparatus for fluorescence detection comprising a means for positioning a solid support and a means for positioning a light source, wherein both means for positioning are independently moveable and wherein the means for positioning the solid support is rotated in a circular path, generally by at least about 5° or more and preferably is rotated at least 360° one or more times, that is, the solid support is spinning, for example, as a CD in an audio CD player.

Any of the above-described apparatuses, as with other apparatuses disclosed herein, can optionally be combined with one or more of any of the components disclosed herein, for example, a solid support, a light source, a collimating means, a focusing means, a splitting means, a polarizing means, a rotating means, a fluorescence detecting means, a reflected light detecting means, a drive mechanism for positioning light, a computer apparatus, or any other components of an invention apparatus disclosed herein.

The methods of the invention can be conveniently used to detect a variety of molecules, in particular in a format for detecting binding activity of a sample. For example, a solid support can be generated to contain a variety of compounds that can be used to test for binding activity against known or unknown compounds or samples. Exemplary compounds useful for testing binding activity of a sample include peptides, oligosaccharides, oligonucleotides, organic molecules, and the like.

As used herein, the term “polypeptide” refers to a peptide, polypeptide or protein of two or more amino acids. A polypeptide can also be modified by naturally occurring modifications such as post-translational modifications, including phosphorylation, lipidation, prenylation, sulfation, hydroxylation, acetylation, addition of carbohydrate, addition of prosthetic groups or cofactors, formation of disulfide bonds, proteolysis, assembly into macromolecular complexes, and the like.

A modification of a peptide can also include non-naturally occurring derivatives, analogues and functional mimetics thereof generated by chemical synthesis. Derivatives can include chemical modifications of the polypeptide such as alkylation, acylation, carbamylation, iodination, or any modification that derivatizes the polypeptide. Such derivatized molecules include, for example, those molecules in which free amino groups have been derivatized to form amine hydrochlorides, p-toluene sulfonyl groups, carbobenzoxy groups, t-butyloxycarbonyl groups, chloroacetyl groups, acetyl groups, or formyl groups. Free carboxyl groups can be derivatized to form salts, amides, methyl and ethyl esters or other types of esters or hydrazides. Free hydroxyl groups can be derivatized to form esters, O-acyl, or O-alkyl derivatives. The imidazole nitrogen of histidine can be derivatized to form N-alkylhistidine. Also included as derivatives or analogues are those polypeptides which contain one or more naturally occurring amino acid derivatives of the twenty standard amino acids, for example, 4-hydroxyproline, 5-hydroxylysine, 3-methylhistidine, homoserine, ornithine or carboxyglutamate, and can include amino acids that are not linked by peptide bonds.

As used herein, the term “nucleic acid” or “oligonucleotide” means a polynucleotide such as deoxyribonucleic acid (DNA) or ribonucleic acid (RNA). A nucleotide incorporated into an oligonucleotide can be naturally occurring nucleotide or non-naturally occurring nucleotides, including derivatives thereof such as phosphoramidates and the like. Such derivatized molecules include analogs of adenosine, substituted adenosines, ethenoadenosine, guanosine, substituted guanosines, inosine, substituted inosines, uridine, 5,6-dihydrouridine, substituted uridines, cytodine, substituted cytodines, thymidine, substituted thymidines, and the like. Derivatized molecules also include glycosylated derivatives of purines, pyrimidines, imidazoles, pyridines, pyrollopyrimidines, pyrazallopyrimidine, pyroles, and other nitrogen containing heterocycles. Derivatized molecules also include modifications of the sugar group to include pentoses, substituted pentoses, deoxy-pentoses, hexoses, substituted hexoses, deoxy-hexoses, and the like.

As used herein, the term “oligosaccharide” refers to polymers of monosaccharides that can be linear or branched. Oligosaccharides include modifications of monosaccharides. As used herein, the term “organic molecule” refers to organic molecules that are chemically synthesized or are natural products.

Methods of synthesis of chemical compounds, including combinatorial chemical libraries, can be used to synthesize a library of ligands. Particularly useful methods for synthesizing chemical compounds include methods for synthesis on solid phase (see, for example, U.S. Pat. No. 5,318,679; Mendonca and Xiao, Med. Res. Rev. 19:451-462 (1999); van Maarseveen, Comb. Chem. High Throughput Screen. 1:185-214 (1998); Andres et al., Comb. Chem. High Throughput Screen. 2:191-210 (1999); Sucholeiki, Mol. Divers. 4:25-30 (1998-1999); Ito and Manabe, Curr. Opin. Chem. Biol. 2:701-708 (1998); Labadie, Curr. Opin. Chem. Biol. 2:346-352 (1998); Backes and Ellman, Curr. Opin. Chem. Biol. 1:86-93 (1997); Kihlberg et al., Methods Enzymol. 289:221-245 (1997); Blackburn and Kates, Methods Enzymol. 289:175-198 (1997); Meldal, Methods Enzymol. 289:83-104 (1997); Merrifield, Methods Enzymol. 289:3-13 (1997); Thuong and Asseline, Biochimie. 67:673-684 (1985)).

Methods for peptide synthesis and the production of peptide libraries are well known to those skilled in the art (Fodor et. al., Science 251:767 (1991); Gallop et al., J. Med. Chem. 37:1233-1251 (1994); Gordon et al., J. Med. Chem. 37:1385-1401 (1994)).

The methods of the invention can be conveniently used to measure a large number of samples in a binding assay using fluorescence detection. Ligands, such as the above described peptides, oligonucleotides, oligosaccharides or organic molecules, can be attached to a solid support in a format suitable for use in an invention apparatus. The ligands bound to the solid support can be contacted with a sample.

As used herein, the term “sample” is intended to mean any biological fluid, body fluid, cell, tissue, organ or portion thereof, that includes one or more different molecules that can function as a binding agent for a ligand on the solid support. The term includes samples obtained or derived from the individual. For example, a sample can be a fluid sample such as body fluid, including blood, plasma, urine, saliva or sputum. A sample can also be a tissue section obtained by biopsy, cells that are placed in or adapted to tissue culture, or fractions or components purified or extracted from a biological fluid, tissue or cell. When using a cell or tissue sample, the sample can be processed to generate an extract that can be conveniently contacted with a solid support using methods well known to those skilled in the art (Harlow and Lane, Antibodies: A Laboratory Manual (Cold Spring Harbor Laboratory Press (1988); Harlow and Lane, Using Antibodies: A Laboratory Manual, Cold Spring Harbor Press (1999)). If desired, the sample can be prepared with denaturants, including detergents such as sodium dodecyl sulfate (SDS). In invention methods for performing fluorescent assays, a sample can also be a control sample, for example, a control of known binding activity for a ligand on the solid support.

In one embodiment, the fluorescence assay is performed so that the ligands bound to the solid support contain a fluorescent moiety. For example, a peptide, oligonucleotide, oligosaccharide, or organic molecule can be synthesized to incorporate a fluorescent moiety such as those disclosed herein. In such an assay format, a sample molecule that binds to the fluorescent ligand can quench fluorescence, which can be detected using an invention apparatus. Therefore, the presence of fluorescence when a molecule is unbound or a decrease or absence of fluorescence when a molecule is bound, which quenches the fluorescent molecule, can be detected using an invention apparatus.

Alternatively, a sample can be a known molecule, and a fluorescent binding assay of the invention can be used to test for binding activity of a library synthesized on a solid support. In such a case where a known molecule is screened for binding activity, the molecule can be modified to incorporate a fluorescent moiety, and the binding of the fluorescent molecule can be detected using an invention apparatus. Rather than measuring the quenching of fluorescence of a fluorescent ligand, as described above, the binding activity of the fluorescent molecule is directly measured. In addition to using a single known molecule that is fluorescently labeled, an extract such as those described above can be modified, for example, by covalently crosslinking a fluorescent moiety, so that fluorescently tagged molecules in a sample can be tested for binding activity.

In still another embodiment of the invention, a molecule bound to a ligand on a solid support can be indirectly detected using a secondary reagent that is specific for the bound molecule. Such a secondary reagent can be a ligand or functional fragment thereof that has binding activity for the molecule to be detected. If a bound molecule to be detected is an antibody, the secondary reagent can be a secondary antibody, for example, an anti-immunoglobulin antibody, that is fluorescently labeled. In such an assay format, a bound primary antibody is detected by bound fluorescently labeled secondary reagent. Methods for detecting antibodies are well known to those skilled in the art (Harlow and Lane, supra, 1988; Harlow and Lane, supra, 1999).

In still another embodiment of the invention, displacement of a bound molecule can be detected using a fluorescence-based assay. For example, a library such as the above-disclosed peptide, oligonucleotide, oligosaccharide or organic molecule libraries can be prebound with a molecule such as an antibody. The prebound complex is contacted with a sample, for example, a control sample or a cell extract sample, and the displacement of the prebound antibody is detected. As described above, the prebound antibody or a secondary reagent specific for the prebound antibody can be fluorescently labeled. An example of such an assay is one where a peptide library is synthesized on a solid support and is prebound with an antibody library. The presence or absence of antibody can be detected by the presence or decrease in fluorescent signal of the directly labeled or indirectly labeled antibody.

As used herein, the term “antibody” is used in its broadest sense to include polyclonal and monoclonal antibodies, as well as antigen binding fragments of such antibodies. An antibody useful in the invention, or antigen binding fragment of such an antibody, is characterized by having specific binding activity for a ligand or sample epitope of at least about 1×10⁵ M⁻¹. Thus, Fab, F(ab′)₂, Fd, Fv, single chain Fv (scFv) fragments of an antibody and the like, which retain specific binding activity for a ligand, are included within the definition of an antibody. Specific binding activity of an antibody for a ligand can be readily determined by one skilled in the art, for example, by comparing the binding activity of an antibody to a particular ligand versus a control ligand that differs from the particular ligand. Methods of preparing polyclonal or monoclonal antibodies are well known to those skilled in the art (see, for example, Harlow and Lane, Antibodies: A Laboratory Manual, Cold Spring Harbor Laboratory Press (1988)).

In addition, the term “antibody” as used herein includes naturally occurring antibodies as well as non-naturally occurring antibodies, including, for example, single chain antibodies, chimeric, bifunctional and humanized antibodies, as well as antigen-binding fragments thereof. Such non-naturally occurring antibodies can be constructed using solid phase peptide synthesis, can be produced recombinantly or can be obtained, for example, by screening combinatorial libraries consisting of variable heavy chains and variable light chains as described by Huse et al. (Science 246:1275-1281 (1989)). These and other methods of making functional antibodies are well known to those skilled in the art (Winter and Harris, Immunol. Today 14:243-246 (1993); Ward et al., Nature 341:544-546 (1989); Harlow and Lane, supra, 1988); Hilyard et al., Protein Engineering: A practical approach (IRL Press 1992); Borrabeck, Antibody Engineering, 2d ed. (Oxford University Press 1995)).

A particularly useful method for generating antibodies is based on using combinatorial libraries consisting of variable heavy chains and variable light chains (Kang et al., Proc. Natl. Acad. Sci. USA, 88:4363-4366 (1991), Huse et al., Science 246:1275-1281 (1989)). The advantage of using such a combinatorial antibody library is that antibodies do not have to be individually generated for each ligand bound to a solid support. No prior knowledge of the exact characteristics of the ligands on the solid support is required when using a combinatorial antibody library.

The invention additionally provides a solid support comprising an assay sector, said assay sector comprising a plurality of sample wells at discrete locations on the solid support, and a data tracking sector, wherein the data tracking sector indicates the position of the multiple discrete locations of the sample wells. The solid support can comprise a library of ligand compounds selected from the group consisting of peptides, oligonucleotides, oligosaccharides, or organic molecules. The ligand compounds can include a flourescent moiety. In addition, the solid support containing a library of ligands can be contacted with a sample, as described above, or an antibody library, as described above, where the bound molecules are fluorescently labeled or contacted with a fluorescently labeled secondary reagent. An invention solid support can be in the format of a CD or DVD, for example, with a spiral arrangement of pits. On the solid support, the data tracking and assay sector can be a single layer, that is, essentially in the same plane on the solid support. The solid support can be assayed for flourescent molecules using any apparatus of the invention, as disclosed herein.

In addition to assay methods using fluorescence detection on arrays, an apparatus of the invention can be used to detect fluorescently encoded data whereby one or more fluorescent molecules are attached to specific assay sectors in such a fashion as to encode data. Data can be encoded using binary code, for instance, where the presence of a fluorescent molecule of a given spectral property in a given location would correspond to a “1” bit while the absence of a fluorescent molecule would correspond to a “0” bit.

It is understood that modifications which do not substantially affect the activity of the various embodiments of this invention are also provided within the definition of the invention provided herein. Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

I claim:

1. An apparatus for fluorescence detection, comprising:
a light source for illuminating an area located on a solid support;
a means for collimating light emanating from said light source, said collimating means disposed to allow the light path of said light to pass between said light source and said solid support;
a means for focusing said collimated light onto said solid support, said focusing means disposed to allow the light path of said light to pass between said collimating means and said solid support;
a means for detecting a fluorescence emission, said fluorescence detecting means disposed to detect fluorescence emission emanating from said solid support;
a means for filtering said fluorescence emission, said filtering means disposed to filter said fluorescence emission onto said fluorescence detecting means.

2. The apparatus of claim 1, wherein said light source is a laser light source.

3. The apparatus of claim 1, wherein light emanating from said light source is of a wavelength of less than about 8×10⁻⁷ meters.

4. The apparatus of claim 1, wherein said fluorescence detecting means is selected from the group consisting of a photomultiplier tube, an avalanche detector, and a CCD array.

5. The apparatus of claim 1, wherein said filtering means is a confocal aperture.

6. The apparatus of claim 1, further comprising a means for splitting light emanating from said light source into two or more split beams of light, said splitting means disposed to allow the light path of said light to pass between said light source and said collimating means.

7. The apparatus of claim 6, further comprising a means for polarizing said beams of light, said polarizing means disposed to allow the light path of said light to pass between said splitting means and said collimating means.

8. The apparatus of claim 7, further comprising a means for rotating the plane of polarization of said collimated light, said rotating means disposed to allow the light path of said light to pass between said collimating means and said focusing means.

9. The apparatus of claim 8, wherein said rotating means is a ¼-wave plate.

10. The apparatus of claim 8, further comprising a means for detecting light reflected from said solid support, said reflected light detecting means disposed to detect light reflected through said focusing means, said rotating means, and said collimating means.

11. The apparatus of claim 10, wherein said reflected light detecting means is a photodetector array.

12. The apparatus of claim 11, wherein said photodetector array is disposed orthogonal to said polarizing means, wherein said rotating means is a ¼-wave plate.

13. The apparatus of claim 1, further comprising a drive mechanism for positioning said light relative to said solid support.

14. The apparatus of claim 1, further comprising a computer apparatus for positioning said light relative to said solid support.

15. An apparatus for fluorescence detection, comprising:
a light source for illuminating an area located on a solid support;
a collimator lens disposed to allow the light path of the light to pass between said light source and said solid support for collimating light emanating from said light source;
a focusing lens disposed to allow the light path of the light to pass between said collimator lens and said solid support for focusing said light onto said solid support;
a fluorescence detector disposed to detect fluorescence emission emanating from said solid support; and
a means for filtering said fluorescence emission, said filtering means disposed to filter said fluorescence emission onto said fluorescence detecting means.

16. The apparatus of claim 15, wherein said light source is a laser light source.

17. The apparatus of claim 15, wherein light emanating from said light source is of a wavelength of less than about 8×10⁻⁷ meters.

18. The apparatus of claim 15, wherein said fluorescence detector is selected from the group consisting of a photomultiplier tube, an avalanche detector, and a CCD array.

19. The apparatus of claim 15, further comprising a diffraction grating disposed to allow the light path of the light to pass between said light source and said collimator lens, said diffraction grating including a grating for splitting light emanating from said light source into two or more split beams of light.

20. The apparatus of claim 19, further comprising a polarizing beam splitter disposed to allow the light path of the light to pass between said diffraction gating and said collimator lens for polarizing said beams of light.

21. The apparatus of claim 20, further comprising a polarization deviator disposed to allow the light path of the light to pass between said collimator lens and said focusing lens for rotating the plane of polarization of said collimated light.

22. The apparatus of claim 21, wherein said polarization deviator is a ¼-wave plate.

23. The apparatus of claim 21, further comprising a photodetector array disposed to detect light reflected from said solid support through said focusing lens, said polarization deviator, and said collimator lens.

24. The apparatus of claim 23, wherein said photodetector array is disposed orthogonal to said polarizing beam splitter, wherein said polarization deviator is a ¼-wave plate.

25. The apparatus of claim 15, further comprising a drive mechanism for positioning said light relative to said solid support.

26. The apparatus of claim 15, further comprising a computer apparatus for positioning said light relative to said solid support.

27. An apparatus for fluorescence detection, comprising:
a light source for illuminating a portion of a solid support;
a means for splitting light emanating from said light source into two or more split beams of light, said splitting means disposed to allow the light path of said light to pass between said light source and said solid support;
a means for polarizing said beams of light, said polarizing means disposed to allow the light path of said light to pass between said splitting means and said solid support;
a means for collimating said polarized light, said collimating means disposed to allow the light path of said light to pass between said polarizing means and said solid support;
a ¼-wave plate disposed to allow the light path of said light to pass between said collimating means and said solid support for converting said collimated light into polarized light;
a means for focusing said polarized light onto said solid support, said focusing means disposed to allow the light path of said light to pass between said ¼-wave plate and said solid support;
a means for detecting a fluorescence emission, said fluorescence detecting means disposed to detect fluorescence emission emanating from said solid support;
a means for filtering said fluorescence emission, said filtering means disposed to filter said fluorescence emission onto said fluorescence detecting means; and
a photodetector array disposed orthogonal to said polarizing beam splitter for detecting light reflected from said solid support.

28. The apparatus of claim 27, wherein said light source is a laser light source.

29. A method of detecting fluorescence on a solid support, comprising:
(a) focusing light onto a solid support using the apparatus of claim 1, said solid support comprising a plurality of sample wells, wherein said sample wells were contacted with one or more fluorescent molecules;
(b) measuring fluorescence emission from a sample well; and
(c) repeating step (b) one or more times, wherein said repeated steps are performed at the same or a different position on said solid support relative to the previous measurement.
